(19) United States
(12) Patent Application Publication
(10) Pub. No.: US 2017/0044030 A1
(43) Pub. Date: Feb. 16, 2017

(54) DEWATERING PROCESS THROUGH FORWARD OSMOSIS USING DEEP EUTECTIC SOLVENTS WITH OR WITHOUT DISPERSED MAGNETIC NANOPARTICLES AS NOVEL DRAW SOLUTIONS

(71) Applicant: COUNCIL OF SCIENTIFIC & INDUSTRIAL RESEARCH, New Delhi (IN)

(72) Inventors: Venkata Rami Reddy ALAMARU, Bhavnagar (IN); Sanna Kotrappanavar NATARAJ, Bhavnagar (IN); Kamalesh PRASAD, Bhavnagar (IN); Dibyendu MONDAL, Bhavnagar (IN); Veera Babu POLISETTI, Bhavnagar (IN); Jitkumar BHATT, Bhavnagar (IN); Ashesh MAHTO, Bhavnagar (IN)

(73) Assignee: COUNCIL OF SCIENTIFIC & INDUSTRIAL RESEARCH, New Delhi (IN)

(21) Appl. No.: 15/305,241

(22) PCT Filed: Aug. 14, 2015
(86) PCT No.: PCT/IN15/00322

§ 371 Date: Oct. 19, 2016

(30) Foreign Application Priority Data
Aug. 20, 2014 (IN) 2356/DEL/2014

(51) Int. Cl. C02F 1/44; B01D 71/56; C02F 1/22; B01D 61/00

(52) U.S. Cl. CPC C02F 1/445; B01D 61/005; B01D 71/56; C02F 1/22; C02F 2103/08

(57) ABSTRACT

The present invention relates to a novel forward osmosis (FO) process for dewatering of a variety of feed solution using low water activity and high osmotic pressure deep eutectic solvent with and without dispersed magnetic nanoparticles as draw solution. In particular, choline chloride-ethylene glycol, choline chloride-glycerol, Fe₃O₄ dispersed in former and latter were utilized as draw solution in FO for one step desalination of brackish and seawater, water recovery from effluent of leather and dye industries, protein and DNA concentration at room temperature. Owing to very low freezing point, the diluted draw solution after FO was recovered through phase separation by chilling at Ca. −10 ° C. with concomitant production of usable water. Although the present invention focused on specific DES and dispersion of Fe₃O₄ as magnetic nanoparticles but use of other DES having high osmotic pressure and low freezing point and other magnetic nanoparticles dispersion are logical extension of present invention.

### FIELD OF THE INVENTION

Present invention relates to enhanced dewatering processes of different feed solution through forward osmosis (FO) using novel draw solutions comprising deep eutectic solvents (DESs) with and without dispersed magnetic nanoparticles. Particularly, the deep eutectic solvents prepared from glycerol (Gly) and ethylene glycol (EG) by mixing with choline-chloride (CC), were utilized as draw solutions in the present invention. More particularly, DESs having very low water activity (a_{w}), freezing point (Tᵣ) and significantly higher osmotic pressure (π), exerts osmotic pull across semi-permeable membrane which is the driving force during FO to achieve rapid dewatering. Still more particularly, DESs were used as draw solutions in FO for (i) desalination of brackish water; (ii) desalination of seawater; (iii) removal of dyes; (iv) Tannery industry's waste water treatment; (v) protein enrichment and (vi) concentration of DNA solution. DESs after FO process can be chilled to phase separate potable water keeping concentrated DESs available for continuous FO process. In another field of invention, when magnetic nanoparticle such as Fe₃O₄ was dispersed in DESs, a greater water flux was achieved. This invention stands as a

Viable, sustainable, cost-effective and environmentally benign alternative to reclaim potable water from sea and brackish water streams; waste water treatment and enrichment of bio-macromolecules.

### BACKGROUND AND PRIOR ART OF THE INVENTION

As the global thirst for drinkable water increases, emerging separation process industry is downing in the tremendous possibilities in seawater desalination. 71% percent of the earth's surface is covered by salt water. People living on the remaining 29% need fresh water to sustain life. But, the World Health Organization (WHO) estimates that there are more than one billion people who lack fresh water. By year 2025 that number is expected to double. More recently, a report predicts world demand for water treatment membranes will rise >9 percent yearly to $25.7 billion by 2017. Developing countries like India, China, Brazil and other in the Mediterranean terrain necessitate even more for industrial purposes. These startling realities demand for rigorous and sustainable alternative separation processes. Therefore, membrane-based water treatment will remain the top market. Moreover, sustainable and energy incentive processes like forward osmosis (FO) process will immensely benefit from expansions or upgrades of water treatment infrastructures. Although the reverse osmosis (RO) process dominates the present desalination industry, serious attempts are being made to adopt snore efficient FO desalination process. In a typical RO process, >99% salt rejection and a specific. flux of 2.5 L·m⁻²·h⁻¹/bar (LMH/bar) has been achieved so fan Recently, focus is being redirected to develop FO process with suitable membrane capable of producing high rate of dewatering in a long term operation. Main advantage of FO is that it operates at very low hydraulic pressure provided suitable DS of high osmotic pressure. But for many years, FO process had suffered setback for not ensuring energy benefits, as draw solute recovery and reuse posed serious challenges. However, in the year 2005. FO process has been revived with the successful use of NH₄HCO₃ as draw solute. Nonetheless, product water recovery and NH₃/CO₂ regeneration needed two-step process. Similarly, there have been several research groups dedicating their time to find suitable DS. There is still a question, is there a best draw solution? There have been several studies following NH₃/CO₂ report through which researchers attempted to address sustainability aspects of DS. Accordingly, DSs have been ranked considering three important parameters namely higher flux performance, draw solute regeneration and solute or draw solution replacement cost. Among all, the energy consumption and efficiency of FO desalination is mainly determined by the recovery or regeneration step. Further, researchers selected seven important draw solutes following rigorous screening criteria with special emphasis given to quality of product water, for model FO desalination process evaluation. Extensive data support and critical evaluation yielded useful information in understanding effects of DS on overall FO outcomes, Nevertheless, additional DS recovery step, toxicity and corrosiveness of the constituents in a long term run pose limited motivation on the sustainability.

Ever since their discovery in 2003, DESs have attracted remarkable interest among research community across chemical sciences. DESs are being used in many applications but, to the best of our knowledge no study so far utilized benign solvent systems as an alternative energy source. Here, we demonstrate use of green solvents choline chloride-ethylene glycol (CC-EG) and choline chloride-glycerol (CC-Gly) as efficient and sustainable draw solutions (DS) or one-step FO desalination process (FIG. 1). In this study, most valued feature of CC-EG as DS is its simple and dynamic recovery process. Inline water reclamation and DS recovery is the exclusive property of present DS in FO desalination.

Reference may be made to the research paper (Solar energy, 2012,86,1351-1358) entitled “Ethanol concentration by forward osmosis with solar-generated draw solution” wherein, the author described a simple, low-cost, and scalable alternative method of removing water from ethanol-water mixture using forward osmosis. The draw solution used was aqueous brine that was regenerated by solar evaporation.

Reference may be made to a comprehensive review article (Desalination and water treatment, 2012, 43, 167-184) entitled “A review of draw solutes in forward osmosis process and their use in modern applications” by Chekli et al., wherein, performance of various draw solutions in the forward osmosis process and selection criteria for suitable draw solutions is elaborated with citing number of relevant research works but there is no report on use of sustainable solvent as draw solution.

Reference may be made to another review article (Journal of Membrane Science 2013,442, 225-237) by Ge et al., entitled “Draw solutions for forward osmosis processes: Developments, challenges, and prospects for the future”, wherein, a comprehensive literatures are being compiled about various draw solutions without mentioning the use of deep eutectic solvent as draw solution.

Reference may be made to the patent (US 20100224476A1 dated September 2010) entitled “Combined membrane-distillation-forward-osmosis systems for the purification of water”, wherein, purification of brackish water or seawater to a potable water has been disclosed. The process includes forward osmosis system wherein concentrated stream from the membrane distillation unit such as brine solution serves as draw solution for the forward osmosis unit.

Reference may be made to another research article by Phuntsho et al., (Environmental Science & Technology 2012, 46,4567-4575) entitled “Blended fertilizers as draw solutions for fertilizer-drawn forward osmosis desalination”, wherein, use of blended one or more fertilizers as draw solution in forward osmosis desalination has been disclosed.

Reference may be made to a patent (KR 2013002666 A dated Jan. 8 2013) entitled “Forward osmosis process using hydrophilic ionic liquid as drive solution” wherein hydrophilic ionic liquids were used as draw solution but use of bio-based DESs was not disclosed. Further, phase separation was achieved using refrigerant and finally reverse osmosis was applied to obtain pure water.

Reference may be made to a patent (WO 2013/148289A1 dated Oct. 3, 2013) entitled “Use of novel draw solutes and combinations in forward osmosis system” wherein the draw solutes having surface active properties were used in forward osmosis for desalination.

Reference may be made to CN101891281 (A) entitled “Composite fine particles of forward osmosis driving solution system and application thereof” discloses preparation of forward osmosis driving solution system consisting of the composite consisting of fine particles of iron oxide grafted by quaternary ammonium chloride or polymer.

Reference may be made to the research article (Materials Letters, 2013, 112,177-179) entitled “Synthesis of spherical Fe₃O₄ magnetic nanoparticles by co-precipitation in cholinechloride/urea deep eutectic solvent” describes manufacturing of Fe₃O₄-DES (mixture of choline chloride and urea) magnetic nanoparticles having high Cu²⁺ adsorption capacity in a composite form with EDTA. But no use was made for FO application.

Reference may be made to the review article (Chem. Soc. Rev., 2012, 41, 7108-7146) wherein the synthesis, properties and application of DESs was disclosed. But no report is available for use of bio-DESs as pent-up energy source to drive FO process.

Reference may be made to a research article (J. Membr. Sci., 2006, 278, 19-25), wherein preparation of thin film composite (TFC) polyamide membrane was disclosed. The membrane used in the present study for FO application was synthesized following this prior art.

### OBJECT OF THE INVENTION

The main object of the present invention is to provide simple and cost effective dewatering process, FO using deep eutectic solvents as potent draw solution.

Another object of the present invention is to utilize choline chloride-ethylene glycol (CC-EG) and choline chloride-glycerol (CC-Gly) and other modified deep eutectic solvents as draw solutions in forward osmosis process.

Yet another object of the present invention is to disperse magnetic nanoparticles (MNPs) in the DESs to make them more efficient draw solutions for forward osmosis process.

Yet another object of the present invention is to energy efficient dewatering of concentrated NaCl, MgSO₄ as feed solutions through FO using DESs and MNPs dispersed DESs as draw solutions employing thin film composite polyamide membrane as semi permeable barrier.

Yet another object of the present invention is to desalination of brackish water and seawater through FO using DES and MNPs dispersed DES as draw solution and thin film composite polyamide membrane as semi permeable barrier.

Yet another object of the present invention is to provide a simple process of water recovery from tannery industries waste water and paint industries waste water through FO using DES and MNPs dispersed DES as draw solution.

Yet another object of the present invention is to concentrate protein and DNA solution efficiently without affecting their structural integrity by FO using DES as draw solution.

Yet another object of the present invention is to recover DES and MNPs dispersed DESs after FO process and reuse them in subsequent FO processes for the dewatering experiments as mentioned above.

### SUMMARY OF THE INVENTION

Accordingly, present invention provides a dewatering process using sustainable deep eutectic solvents with or without magnetic nanoparticles dispersion as draw solutions through forward osmosis for energy efficient desalination, waste water treatment, protein and DNA concentration which comprise the following steps:
(i) preparing of DES by adding choline chloride in ethylene glycol or glycerol in 1:2 molar ratio and heating the mixture at a temperature in the range of 70° to 90° C.,
(ii) dispersing 0.5 to 1% iron oxide based magnetic nanoparticles in the above solvents as obtained in step (i),
(iii) utilising the solvent obtained in steps (i) and (ii) respectively as draw solution in membrane based FO processes to drive efficient dewatering of different feed solutions,
(iv) freezing the diluted draw solutions obtained after step (iii) at a temperature in the range of −4 to −10° C. to recover potable water and draw solution,
(v) reusing the recovered draw solutions obtained in step (iv) for the subsequent FO process for dewatering until it loses its driving force. In an embodiment of the present invention, the driving force is osmotic pressure.

In another embodiment of the present invention, the DES with and without magnetic nanoparticles have density in the range of 1.10-1.2g·cm⁻³; viscosity in the range of 25-250 cP; conductance at room temperature range in the range of 4-15 mS; melting temperature in the range of −15° C. to −20° C.; freezing point in the range of −70° C. to −35° C.; water activity in the range of 0.1-0.12; osmotic pressure in the range of 300-400 atm; and chemical potential range in the range of 5-6 kJ·mol⁻¹. In an embodiment of the present invention, the density of Choline chloride-ethylene glycol is in the range of 1.10-1.15 g·cm⁻³; viscosity is in the range of 25-35 cP; conductance at room temperature is in the range of 10-15 mS; melting temperature is in the range of −10° C. to −15° C.; E_{T}(30) value is in the range of 55-60 kCal·mol⁻¹ and freezing point is in the range of −60° C. to −70° C.

In another embodiment of the present invention, the water activity (a_{w}) of Choline chloride-ethylene glycol is in the range of 0.10 to 0.12; chemical potential is in the range of 5 kJ/mol to 6 kJ/mol and osmotic pressure is in the range of 350 atm to 400 atm.

In yet another embodiment of the present invention, the density of Choline chloride-glycerol is in the range of 1.15-1.19 g·cm⁻³; viscosity is in the range of 220-240 cP; conductance at room temperature is in the range of 4-6 mS; melting temperature is in the range of 15° C. to 20° C.; E_{T}(30) value is in the range of 55-60 kCal.mol⁻¹ and freezing point is in the range of −35° C. to −45° C.

In yet another embodiment of the present invention, the water activity (₄) of Choline chloride-glycerol is in the range of 0.10 to 0.12; chemical potential is in the range of 5 kJ/mol to 6 kJ/mol and osmotic pressure is in the range of 300 atm to 350 atm.

In yet another embodiment of the present invention, water activity of the DESs as mentioned in step (i) do not change much with dilution up to 60-70% dilution with water.

In yet another embodiment of the present invention, even after 3-4 times dilution with water, the osmotic pressures of DES were above 100 atm. In yet another embodiment of the present invention, the FO processes as mention in step (iii) are not limited to desalination of brackish and seawater, waste water treatment of paint industry and leather industries effluent, protein enrichment and DNA concentration.

In yet another embodiment of the present invention, the membrane used in step (iii) for FO process to evaluate the efficacy of DESs as draw solution is not limited to thin film composite polyamide membrane.

In yet another embodiment of the present invention, the FO processes as mention above were performed at room temperature (25±2° C.) and low pressure (0 to 1 bar). In an embodiment of the present invention, the draw solution to feed solution ratio in various FO processes are in the range of 1:5-1:10.

In yet another embodiment of the present invention, a water flux of 5-7 LMH/bar was obtained using DES as draw solution and 2000 ppm NaCl as feed solution. The ratio of draw solution to feed solution was 1:10.

In yet another embodiment of the present invention, a water flux of 5-8 LMH/bar was obtained using DES as draw solution and 2000 ppm MgSO₄ as feed solution. The ratio of draw solution to feed solution was 1:10.

In yet another embodiment of the present invention, a water flux of 7-10 LMH/bar was obtained using magnetic nanoparticles dispersed DES as draw solution and 2000 ppm NaCl as feed solution. The ratio of draw solution to feed solution was 1:10.

In yet another embodiment of the present invention, a water flux of 6-8 LMH/bar was obtained using magnetic nanoparticles dispersed DES as draw solution and 2000 ppm MgSO₄ as feed solution. The ratio of draw solution to feed solution was 1:10.

In yet another embodiment of the present invention, a water flux of 3-10 LMH/bar was obtained using DES as draw solution and brackish water as feed solution. The ratio of draw solution to feed solution was 1:10.

In yet another embodiment of the present invention, a water flux of 3-6 LMH/bar was obtained using DES as draw solution and seawater as feed solution. The ratio of draw solution to feed solution was 1:10.

In yet another embodiment of the present invention, a water flux of 7-12 LMH/bar was obtained using magnetic nanoparticles dispersed DES as draw solution and brackish water as feed solution. The ratio of draw solution to feed solution was 1:8.

In yet another embodiment of the present invention, 80 -95% recovery of potable water could be achieved from tannery industries effluent using DES as draw solution with an average flux of 1-3 LMH/bar.

In yet another embodiment of the present invention, a water flux of 4-6 LMH/bar with 100% rejection was obtained using DES as draw solution and 15-100 ppm reactive black 5 dye as feed. The ratio of draw solution to feed solution was 1:5. Isopropyl alcohol treated TFC membrane was utilized for the same.

In an embodiment of the present invention, 3-10 fold concentration of protein and DNA are demonstrated without disturbing the structural integrity of the bio-macromolecules. In yet another embodiment of the present invention, 7-10 fold concentration of protein could be achieved with a water flux of 3-6 LMH/bar with 100% rejection using DES as draw solution and 100-250 ppm BSA as feed solution. The ratio of draw solution to feed solution was 1:5. Isopropyl alcohol treated TFC membrane was utilized for the same.

In yet another embodiment of the present invention, 3-5 fold concentration of DNA could be achieved with a water flux of 3-5 LMH/bar with 100% rejection using DES as draw solution and 300-500 ppm DNA as feed solution. The ratio of draw solution to feed solution was 1:5. Isopropyl alcohol treated TFC membrane was utilized for the same.

In yet another embodiment of the present invention, structure of protein and DNA remained intact during the course of FO.

In yet another embodiment of the present invention, the rate of dewatering can be enhanced further by changing the ratio of draw solution to feed solution.

In yet another embodiment of the present invention, DESs were recovered from diluted draw solutions after FO by phase separation through chilling at −4° C. to −12° C. depending upon % of dilution.

In yet another embodiment of the present invention, reuse of the recovered DES (contain 10-30% water) after FO resulted very nominal i.e. 2-10% reduction in water flux.

### BRIEF DESCRIPTION OF DRAWINGS

FIG. 1(a): FT-IR spectra showing bending vibration peaks of DES (CC-EG) at different dilution.

FIG. 1(b) shows water activity and area of bending vibration of DESs as function of % dilution of DES with water.

FIG. 1(c) shows osmotic pressure, it depression pattern as function of DES dilution.

FIG. 2: Overview of FO desalination and DES recovery strategy adopted in the present invention.

FIG. 3: Photograph of FO assembly employed in the present invention.

FIG. 4: Water flux trends of desalinated water for (a) brackish water and (b) sea water desalination using DES as draw solution.

FIG. 5: Photograph of phase separated water and DES (CC-EG) portion when chilled at Ca. −10° C. after FO desalination of brackish water and concentration of their constituents.

### DETAILED DESCRIPTION OF THE INVENTION

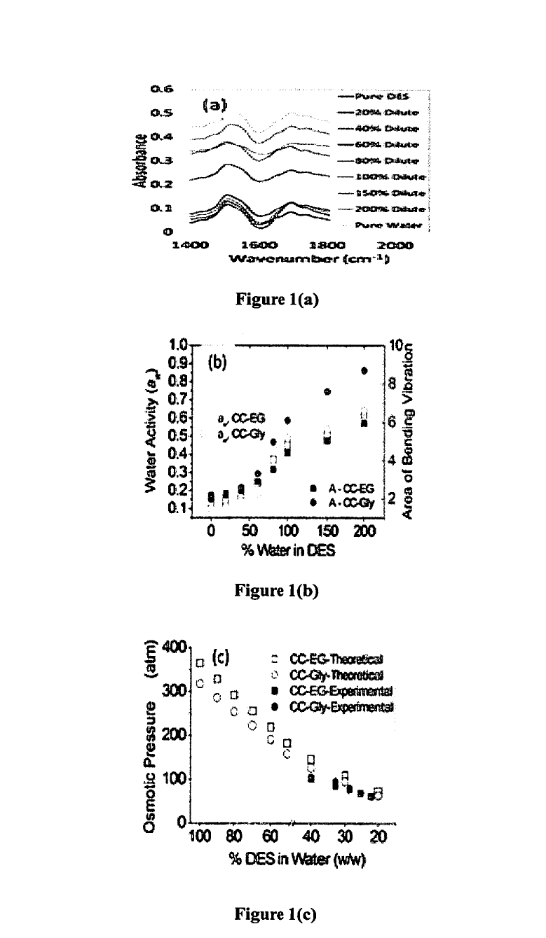

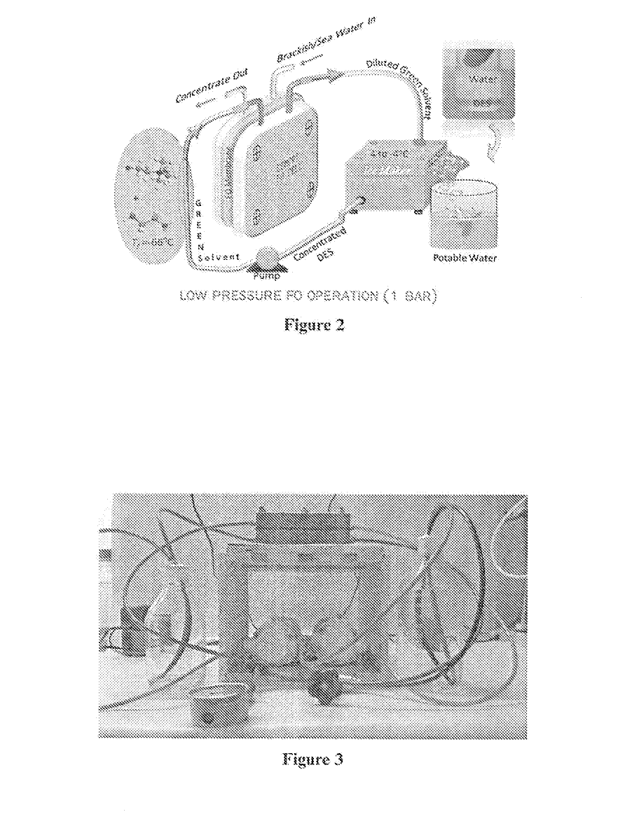

The present invention shows one-step FO processes using green solvents such as CC-EG and CC-Gly with and without dispersion of magnetic nanoparticles as sustainable and efficient draw solutions. DESs are in being used in many applications but, no study so far utilized benign solvent systems as an alternative energy source. In this invention, most valued feature of CC-EG as DS is its simple and dynamic recovery process. Inline water reclamation and draw solution recovery is the exclusive property of present draw solution in FO desalination. Among other advantages, choline is a dietary compound used as food ingredient. EG is being used as antifreeze agent and Gly is a widely used food additive. In FO process, feed and draw solutions are circulated in adjacent chambers separated by a thin-film composite (TFC) polyamide membrane. All DES constituents are readily available in the open market at very low cost, EG (<0.2 $/kg), Gly (˜3 $/kg) and CC (˜2 $/kg). A quaternary ammonium salt CC, coupling with hydrogen bond donor like EG (η=33 cP) and Gly (η=222 cP) makes viscous DES combination. Using very low feed pressure (˜1 bar), continuous osmotic flow of water to draw solution was achieved from different feed stock. Generally, water activity in DES is low, in particular CC-EG and CC-Gly have lowest a_{w}<0.1. To understand the colligative nature of DES, conductance, a_{w} and π were measured at different dilution. Bending vibration peak of water in FTIR is centered on 1600 cm⁻¹ and absorbance of IR increases linearly with the water concentration in DES (FIGS. 1a & 1b). Vibration absorption increases with the dilution which is equivalent the activity of water in mixture. Though, the sharp rise in area integrated absorbance noticed 60% dilution, but a_{w} remains <0.6 even after 200% dilution. Therefore, diluting a DES directly distresses the osmotic forces available for dewatering process when used in FO. The π declines with respect to DES dilution were measured and the decline pattern in the osmotic pressure upon dilution is shown in FIG. 1c. Pristine CC-EG and CC-Gly in theory carries an osmotic pressure, π>300 atm. considering instrument's (WESCOR-Vapro 5600 Osmometer) detection limits, experimental it data were measured only after diluting DES >60% (w/w). It is to note that even after 60% diluted DES effectively exert osmotic pressure as high as >100 atm making it a suitable alternative and green energy source. To prove the efficacy of the DESs as draw solution, a number of FO processes were investigated for desalination of brackish and seawater, industrial waste water treatment and protein enrichment. In all cases good flux were recorded. Interestingly when magnetic nanoparticles were dispersed in the DESs its efficacy as draw solution further improved as much as 30-50% increase in water flux were recorded. To reclaim DES and recover potable water, diluted (after 6 h) DESs was subjected to chilling process. Once the CC-EG was diluted drawing water from feed (ca. ˜4 fold dilution in 6 h batch FO run), dilute was subjected to chilling process to separate icy layer from active and concentrated CC-EG Both the portions were simultaneously separated out and tested for their constituent. In a situation where ice-maker provided as inline separator, CC contamination level in product water can be reduced considerably by controlled (˜20%/cycle) separation of uppermost portion of icy layer. The total process is depicted schematically in FIG. 2.

Accordingly, present invention provides a dewatering process using sustainable deep eutectic solvents with or without magnetic nanoparticles dispersion as draw solutions through forward osmosis for energy efficient desalination, waste water treatment, protein and DNA concentration which comprise the following steps:
(i) preparing of DES by adding choline chloride in ethylene glycol or glycerol in 1:2 molar ratio and heating the mixture at a temperature in the range of 70° to 90° C.,
(ii) dispersing 0.5 to 1% iron oxide based magnetic nanoparticles in the above solvents as obtained in step (i),
(iii) utilising the solvent obtained in steps (i) and (ii) respectively as draw solution in membrane based FO processes to drive efficient dewatering of different feed solutions,
(iv) freezing the diluted draw solutions obtained after step (iii) at a temperature in the range of −4 to −10° C. to recover potable water and draw solution, and
(v) reusing the recovered draw solutions obtained in step (iv) for the subsequent FO process for dewatering until it loses its driving force.

The present invention recognise that nontoxic, low cost, large availability, low water activity and high osmotic pressure, DESs are the ideal draw solutions and unconventional energy resources to drive dewatering through energy less FO processes.

The present invention recognise that magnetic nano particles can be synthesised in DESs and easily dispersible in DESs, magnetic nanoparticle dispersed DESs were explored further as efficient draw solution for one step FO processes.

The present invention recognise high water flux obtained using thin film composite polyamide membrane, and DESs and magnetic nano particles dispersed DESs as draw solutions, sustainable desalination of both brackish and seawater, waste water treatment, DNA and protein enrichment was demonstrated.

The present invention recognise that magnetic nano particles dispersed Fe₃O₄ exerts higher osmotic gradient higher water fluxes in FO desalination process were recorded compared to DESs as draw solution.

The present invention recognise the very low freezing point of some bio-based DESs as draw solutions, they are easy to recover after FO process through phase separation by simple chilling with concomitant production of potable water.

The present invention recognise easy recovery of magnetic nano particle dispersed in DESs using magnet, magnetic nano particles dispersed DESs too are reusable for continuous FO process in sustainable way.

### EXAMPLES

### Example 1

The bio-deep-eutectic solvents (bio-DESs) were prepared by the method as mentioned in the prior art. In a typical procedure, both the hydrogen bond donor i.e., choline chloride (S D Fine chemicals, Mumbai, India) and hydrogen bond acceptor i.e., ethylene glycol (S D Fine chemicals, Mumbai, India) was mixed in 1:2 molar ratio and heated at 80° C. with constant stirring for 2 h until homogenous and colorless liquid of was formed. This liquid was used as choline chloride-ethylene glycol (CC-EG) based deep eutectic solvent. For the synthesis of choline chloride-glycerol (CC-Gly) based DES similar procedure was followed except glycerol (S D Fine chemicals, Mumbai, India) was taken in place of ethylene glycol. The properties of the DESs as draw solution in FO are provided in Table 1.

TABLE 1
Properties of DESs used in the present
invention as efficient draw solution
in FO applications

| | Draw solutions | |
|---|---|---|
| Properties | CC-EG | CC-Gly |
| Density at r.t (g · cm⁻³) | 1.13 | 1.16 |
| Viscosity η at r.t (cP) | 33 | 222 |
| Conductance at r.t (mS) | 11.9 | 4.9 |
| Tₘ(•C) | −12.9 | 17.8 |
| T_{f} (•C) | −66 | −40 |
| ET (30) (kCal · mol⁻¹) | 57.3 | 58.3 |
| Water activity a_{w} | 0.12 | 0.10 |
| Osmotic pressure π (atm), | 365 | 317 |

This example teaches synthesis of DESs and their properties used in the present invention as draw solutions.

### Example 2

In a typical procedure, 5.4 gm of FeCl₃ and 3.6 gm of urea were dissolved in a 200 mL of water. The mixture was heated at 90° C. for 2 h and then cooled at room temperature. After cooling, 2.8 gm of FeSO₄ was added and stirred for 15 minutes.

The pH of this mixture was adjusted to 10 by adding 0.1 M NaOH solution. Black precipitate of Fe₃O₄ was obtained which was sonicated for 30 minutes. The precipitate was separated by the centrifugation; washed with deionized water and dried.

This example teaches synthesis of magnetic nanoparticle (Fe₃O₄, used in the present invention) in aqueous media.

### Example 3

In 80% (v/v) aqueous solution of CC-EG 2.8 gm of FeSO₄·7 H₂O (Sigma Aldrich) and 4 gm of Fe₂(SO₄)₃·XH₂O (TCI, Japan) was dissolved at room temperature. Liquor Ammonia (25% ammonia solution) was added drop wise to the reaction mixture with constant stirring at 600 rpm till the pH reached to 10. The temperature of the reaction mixture was gradually raised to 60° C. and maintained for 1 hour with continuous stirring. The reaction mixture was allowed to cool at room temperature and 500 mL of water was added to the reaction mixture. Iron Oxide nanoparticles were precipitated and separated with the help of a magnet. The nanoparticles were washed 4-5 times with pure water until the pH became 7. It was dried in oven at 60° C. for 12 h.

This example teaches synthesis of magnetic nanoparticles of iron oxide (used in the present invention) in deep eutectic solvent.

### Example 4

The iron oxide based magnetic nanoparticles obtained in above example 2 or 3 was directly dispersed in CC-EG and CC-Gly, respectively. Briefly, 0.5-1.0% (w/v) iron oxide was added to DES and the mixture was sonicated for 0.5 h until a homogeneous dispersion obtained. This iron oxide based magnetic nanoparticles dispersed DESs were utilized as draw solution in FO process.

This example teaches preparation of magnetic nanoparticles dispersed DESs which were utilized as draw solution in the present invention.

### Example 5

Laboratory made thin film composite (TFC) polyamide membrane was used in FO experiments of the present invention. Membrane was synthesised following an earlier report as taught in the prior art. TFC membrane is comprised of polysulfone- ultrafiltration (15% polymer concentration) supporting layer with polyamide selective skin made up of trimesolyl chloride (TMC, 0.125% aqueous solution) and m-phenylenediamine (MPD, 5% in hexane) through interfacial polymerization. Post treatments were carried out by treating with citric acid (2%) and water wash followed by glycerol coating (20%). In all the experiments, before fitting the membrane to testing kit glycerol was washed to regenerate original polyimide layer. When operated in reverse osmosis (RO) mode at 5 bar pressure, a flux of 26.45 L·m⁻²·h^{31 1} and rejection of 94.9% were observed for desalination of 2000 ppm brackish water. High rejection efficiency was observed for desalination of seawater also, albeit at high applied pressure. In view of the satisfactory flux and rejection even at low (5 bar) operating pressure in experiments with brackish water, the membrane was considered suitable for FO application.

This example teaches the fabrication of TFC polyamide membrane employed in the present invention and its performance in RO mode at low pressure.

### Example 6

A flat sheet membrane testing kit with 0.0057 m² active membrane surface area was fabricated in the Institute's workshop. Pressure booster pumps capable of maintaining a pressure between 0-10 bars were used for circulation of feed solution and draw solution taken in suitably sized glass containers. After several trials, an optimized inlet operating pressure of I bar was adopted. A restricting needle valve was provided on the feed outlet of the membrane kit to pressurize the feed solution. For the circulation of both feed solution and draw solution, RO booster pumps (KEMFLO) were used with nominal flow rate of 1.8 LPM and maximum input pressure capacity of 60 psi. A picture of the unit is shown in FIG. 3.

This example teaches the fabrication of membrane testing kit and FO process in the present invention

### Example 7

In a typical FO process, a feed tank containing IL 2000 ppm NaCl as feed solution and another tank having 100 mL DES (CC-EG) as draw solution were connected to a pump. A TFC membrane as described in example 5 was used. An optimized inlet operating pressure of 1 bar at room temperature (22±2° C.) was adopted. Pump specifications are mentioned in example 6. The volume in the feed tank was observed to be decreasing gradually and permeate flux was volumetrically measured every hour for each feed solution concentration. The experiment was terminated after 10 h to evaluate feed solution and draw solution for their concentration variants. The initial and the final volume of feed solution were used to calculate desalinated water recovery and flux.

For dewatering of 2000 ppm MgSO₄ using CC-EG as draw solution, similar experimental procedure as mentioned above was followed except 1 L 2000 ppm MgSO₄ solution was taken in feed tank.

The above two dewatering experiments (i.e. dewatering of 2000 ppm of NaCl and MgSO₄) was repeated with 100 mL of CC-Gly, magnetic nanoparticles dispersed CC-EG and magnetic nanoparticles dispersed CC-Gly, respectively, keeping all other things unaltered. Afresh membrane was used for each experiment.

Table 2 shows detailed data of thin film composite (TFC) membrane performance using different DSs. Pristine DES solution (CC-EG) showed 5.2 and 5.32 LMH/bar flux for NaCl feed with 42% water recovery, whereas CC-EG-Fe₃O₄ showed improved performance for their flux as 7.5 and 6.43 LMH/bar with 44% water recovery from feed solution. On the other hand, the draw solution, CC-Gly produced 7.54 and 4.5 LMH/bar flux for NaCl and MgSO₄ feeds with 33.33% and 20.5% water recovery. Interestingly, MNPs dispersed DES (CC-Gly-Fe3O4) was consistent to give more than 50% water recovery from 2000 ppm NaCl feed leaving behind 50.9% concentrated NaCl to feed solution.

TABLE 2
Forward osmosis results comprising desalinated water flux, %
concentration of feed at the end of 10 hour experiment using DES and
MNPs dispersed DES solvents as draw solutions.

| | | | | |
|---|---|---|---|---|
| Draw solution | CC-EG | CC-EG- | CC-Gly | CC-Gly- |
| | | Fe₃O₄ | | Fe₃O₄ |

| | | | | | | | |
|---|---|---|---|---|---|---|---|
| Feed solution* | NaCl | MgSO₄ | NaCl | MgSO₄ | NaCl | MgSO₄ | NaCl |
| % Concentration | 41.4 | 42.9 | 45.04 | 44.16 | 33.33 | 20.50 | 50.9 |
| % Water | 31.7 | 36.2 | 73.6 | 29.2 | 43.00 | 20.50 | 58.0 |
| Recovery | | | | | | | |
| LMH/Bar | 5.2 | 5.32 | 7.50 | 6.43 | 7.54 | 4.519 | 7.3 |

*Feed solutions were prepared following brackish water standards (2000 ppm).

This example teaches efficacy of DESs and magnetic nanoparticle dispersed DESs as efficient draw solutions for FO application. Magnetic nanoparticles dispersed DESs showed superior osmotic pull efficiency than pure DESs.

### Example 8

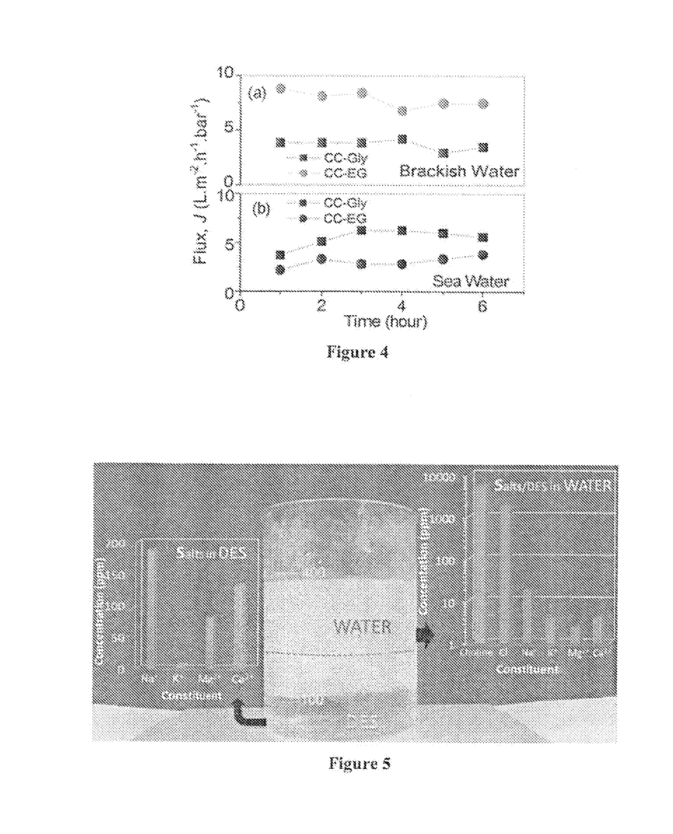

In a typical FO process desalination of brackish water (collected from institute's bore well) containing Na⁺=1179 ppm; K⁺=31 ppm; Mg²⁺=477 ppm; Ca²⁺=903 ppm; and Cl⁻¹=5650 ppm, was performed taking 1 L of brackish water in feed tank and 100 mL of CC-EG or CC-Gly or magnetic nanoparticles dispersed CC-EG or magnetic nanoparticles dispersed CC-Gly as draw solution. A TFC membrane of example 5 was fitted in a FO cell as described in example 6 with 0.0057 m² active membrane surface area and feed and draw solution was allowed to flow continuously. Brackish water passes through membrane active layer at 1 bar applied pressure and room temperature. Brackish water desalination was achieved at the average flux of 7.85 and 3.71 LMH/bar using CC-EG and CC-Gly as draw solution (FIG. 4(a)), respectively.

This example teaches desalination of brackish water with high flux by FO using DESs with and without dispersion of magnetic nanoparticles as draw solution.

### Example 9

In a typical FO process desalination of seawater containing Na⁺=11800 ppm; K⁺=900 ppm; Mg²⁺=1103 ppm; Ca²⁺=600 ppm; and Cl⁻=19600 ppm, was performed taking 1 L of seawater as feed solution and 100 mL of CC-EG or CC-Gly as draw solution. Other experimental parameters were similar of example 5, 6 and 8 respectively. Seawater desalination was achieved at the average flux of 3.04 and 5.48 LMH/bar using CC-EG and CC-Gly as draw solution (FIG. 4(b)), respectively.

This example teaches desalination of seawater with high flux by FO using DESs as draw solution.

### Example 10

The TFC membrane as described in example 5 was treated with isopropyl alcohol (IPA) by dipping for 5-7 minutes. The IPA treated TFC membrane was then kept overnight in RO water (Conductance 170 μS). Before using the membrane for FO process it was washed thoroughly with RO water. Nano filtration experiments of different concentration of MgSO₄, NaCl, reactive Black 5 (Dye content-55%; Sigma Aldrich), BSA protein (minimum assay-97%; SDFCL, Mumbai, India) were performed using IPA treated TFC membrane at 6 bar applied pressure. Table 3 provides the data of flux and rejection for nano filtration experiment.

This example teaches pretreatment of TFC membrane for some specific applications employed in the present invention.

TABLE 3
Flux and rejection data of different feed
solutions using IPA treated TFC membrane.

| Feed | Concentration | Flux | % |
|---|---|---|---|
| solution | (ppm) | (LMH) | Rejection |
| MgSO₄ | 1180 | 6.5 ± 0.5 | 92 |
| NaCl | 3410 | 5.0 ± 0.5 | 86 |
| RB5 | 20 | 7.0 ± 0.5 | 100 |
| BSA | 200 | 7.5 ± 0.5 | 100 |

### Example 11

In a typical FO procedure, 1 L of 15 ppm aqueous solution of standard reactive black 5 dye was taken as feed solution and 200 mL of CC-EG was taken as draw solution. IPA treated TFC membrane as described in example 10 was fitted in double stack FO cell (2 chambers for feed solution and 1 chamber for draw solution) with active membrane surface area of 0.01265 m² was employed for this experiment. At 1 bar applied pressure and at room temperature operation 90% of recovery of water was demonstrated at an average flux of 5.1 LMH/bar with 100% rejection of dye. This example teaches removal of dye can be feasible from effluent of paint industries by FO using DES as draw solution.

### Example 12

In a typical FO procedure, 1 L of simulated leather industry waste water (containing 2000 ppm NaCl; 100 ppm plant polyphenol; 100 ppm phenol-HCHO; 100 mg red brown dye; and 1 mL synthetic oil) was taken as feed solution and 130 mL of CC-EG was taken as draw solution. TFC membrane as described in example 5 was fitted in single stack FO cell (1 chamber for feed solution and 1 chamber for draw solution) with active membrane surface area of 0.0063 m² was employed for this experiment. At 1 bar applied pressure and at room temperature operation 95% recovery of water was achieved at an average flux of 1.0 LMH/bar. There was no colour on the draw side which reflects the effective rejection of all the polyphenols and dye in the simulated leather waste solution.

This example teaches waste effluent treatment and recover of water from leather industry waste stream

### Example 13

In a typical FO procedure, 0.5 L of 500 ppm DNA (from salmon milt, TCI chemicals, Japan) solution in 0.01 M Tris-HCl buffer (1.3 gm of CC-EG was added to stabilize DNA) was taken as feed solution and 100 mL of CC-EG was taken as draw solution. TFC membrane as described in example 5 was fitted in single stack FO cell (1 chamber for feed solution and 1 chamber for draw solution) with active membrane surface area of 0.0057 m² was employed for this experiment. At 1 bar applied pressure and at room temperature operation 1781 ppm of concentrated DNA (i.e. ca 3.5 times) was yielded at an average flux of 3.1 LMH/bar. No loss of DNA was confirmed at the draw side by spectrophotometer and no denaturation of DNA was confirmed by CD spectra.

This example teaches ca. 4 fold concentration of DNA solution by FO using DES as draw solution.

### Example 14

In a typical FO procedure, 1 L of 200 ppm bovine serum albumin (BSA, Sigma Aldrich) solution in 0.005 M Tris-HCl buffer was taken as feed solution and 150 mL of CC-EG was taken as draw solution. Isopropyl alcohol treated TFC membrane as described in example 10 was fitted in double stack FO cell (2 chambers for feed solution and 1 chamber for draw solution) with active membrane surface area of 0.01265 m² was employed for this experiment. At 1 bar applied pressure and at room temperature operation 1460 ppm of concentrated BSA (i.e. ca 7 times) was yielded at an average flux of 4.67 LMH/bar. No loss of BSA was confirmed at the draw side by spectrophotometer.

This example teaches ca. 7 fold concentration of protein solution by FO using DES as draw solution.

### Example 15

In a typical FO procedure, 1 L of Kappaphycus alvarezii seaweed sap (initial TDS=32.8 ppt, conductance=59.7 mS) was taken as feed solution and 200 mL of CC-EG was taken as draw solution. TFC membrane as described in example 5 was fitted in double stack FO cell (2 chambers for feed solution and 1 chamber for draw solution) with active membrane surface area of 0.01265 m² was employed for this experiment. At 1 bar applied pressure and at room temperature operation 42.2 ppt of concentrated sap with conductance 77.2 mS was achieved at an average flux of 1.6 LMH/bar.

This example teaches concentration of seaweed sap by FO using DES as draw solution.

### Example 16

After 5-10 h of FO run the draw solution (CC-EG) gets diluted to ca 4-fold from brackish water as feed. The diluted draw solution was thereafter used to recover DES and fresh water in a freezing container between 0° C. and −10° C. temperatures. When kept at deep freezer (Whirlpool refrigerator, 300 DLX PROTTON SNOW WHITE), the diluted draw solution (400 mL) phase separates out (FIG. 9). The ice part contained fresh water while the liquid part contained DES. From this two layer 300 mL of fresh water with acceptable contamination of choline chloride (FIG. 5) was recovered while DES with 20-30% dilution (v/v) by water was recovered and reused for subsequent FO desalination process. Inserted graphs clearly indicate high quality potable water (<10 mg/L) from icy layer and CC-EG attaining pristine status ready for next cycle. In a robust evaluation step, choline (5200 mg/L) and chloride levels in water marginally higher compared to standard upper limit intake for adult men (Choline, 3500 mg/day).

This example teaches recovery of DES for the subsequent FO processes with simultaneous production of potable water.

### ADVANTAGES OF THE INVENTION

The advantages of the present invention are
(i) Use of inexpensive, nontoxic, abundant and green solvent bestowed with excellent properties such as very low water activity, significantly high osmotic pressure, as ideal draw solution for forward osmosis processes.
(ii) Ease of dispersion of magnetic nanoparticles in high amount in such solvents makes it more effective as draw solution to drive dewatering processes by FO.
(iii) Useful properties such as high density, very low freezing point, not drastic change in depression of freezing point of water with dilution, the draw solutions of the present invention are suitable for instant recovery through chilling and reuse for the subsequent FO process.
(iv) Recognising that simple and dynamic recovery process of the draw solutions, inline potable water reclamation is another advantage of present draw solution in FO processes such as desalination, waste water treatment, protein enrichment and biomedical applications.
(v) Recognising that magnetic nano particle dispersed in DESs can be recovered by magnet, magnetic nano particles dispersed DESs too are reusable for continuous FO process in sustainable way.
(vi) The FO processes using DES as draw solution were carried out both in lab scale to bench scale and similar observation were recorded indicating that the process of the present invention is readily scalable.

We claim:

1. A dewatering process using sustainable deep eutectic solvents (DES) with or without magnetic nanoparticles dispersion as. draw solutions through forward osmosis (FO) comprising the steps;
(i) preparing a deep eutectic solvent (DES) by adding choline chloride in ethylene glycol or glycerol in 1:2 molar ratio to obtain a mixture and heating the mixture at a temperature in the range of 70° to 90° C.;
(ii) optionally dispersing 0.5 to 1% iron oxide based magnetic nano/particles in the above solvents as obtained in step (i);
(iii) utilising the solvent obtained in steps (i) or (ii) respectively as a draw solution in a membrane based forward osmosis (PO) processes to drive efficient dewatering of different feed solutions at room temperature and pressure in the range of 0-1 bar;
(iv) freezing the diluted draw solution obtained after step (iii) at a temperature in the range of −4 to −10° C. to recover potable water and draw solution; and
(v) reusing the recovered draw solution obtained in step (iv) for subsequent forward osmosis (FO) process for dewatering until it loses its driving force.

2. The process as claimed in claim 1, wherein the driving force is osmotic pressure.

3. The process as claimed in claim 1, wherein the deep eutectic solvent (DES) with and without magnetic nanoparticles have density in the range of 1.10-1.2 g·cm⁻³, viscosity in the range of 25-250 cP; conductance at room temperature in the range of 4-15 mS; melting temperature in the range of −15° C. to −20° C.; freezing point in the range of −70° C. to −35° C.; water activity in the range of 0.1-0.12; osmotic pressure in the range of 300-400 atm; and chemical potential range in the range of 5-6 kJ·mol⁻¹.

4. The process as claimed in claim 1, wherein the membrane is a thin film composite polyamide membrane, whereas, forward osmosis (FO) process of dewatering is selected from the group consisting of desalination of brackish and seawater, water recovery from paint industry and leather industry's effluents, protein enrichment and DNA concentration.

5. The process as claimed in claim 1, wherein the draw solution to feed solution ratio in various forward osmosis (FO) processes is in the range of 1:5-1:10.

6. The process as claimed in claim 1, wherein the potable water can be recovered in the range of 80-95% from tannery industry effluent.

7. The process as claimed in claim 1, wherein the recovered draw solution after forward osmosis (FO) containing 10-30% (v/v) water is effective for subsequent dewatering processes with only 2-10% decline of film

8. The process as claimed in claim 1, wherein the potable water can be produced simultaneously during recovery of draw solution obtained after forward osmosis (FO) through chilling.
